(19) United States
(12) Patent Application Publication
(10) Pub. No.: US 2020/0260756 A1
(43) Pub. Date: Aug. 20, 2020

(54) APPARATUS FOR DELIVERING FROZEN CONFECTION COMPRISING PARTICULATE MATERIAL

(71) Applicant: Conopco, Inc., d/b/a UNILEVER, Englewood Cliffs, NJ (US)

(72) Inventors: BEN JAMES CRUNDWELL, Royston (GB); Varkey Berty JACOB, Bedford (GB); Paul SCOTT, Histon (GB)

(21) Appl. No.: 16/067,880

(22) PCT Filed: Dec. 9, 2016
(86) PCT No.: PCT/EP2016/080424

§ 371 Date: Jul. 3, 2018

(30) Foreign Application Priority Data
Jan. 8, 2016 (EP) 16150638.1

(51) Int. Cl. A23G 9/28; A23G 9/08; A23G 9/32

(52) U.S. Cl. CPC A23G 9/281; A23G 9/322; A23G 9/08

(57) ABSTRACT

An apparatus (10) for dispensing frozen confectionery comprising particulate material, the apparatus comprising: a frozen confectionery dispenser, a particulate material dispenser, and a handle means (14); wherein the handle means (14) is adapted to provide a first actuation action for activation of the frozen confectionery dispenser and a second actuation action for activation of the particulate material dispenser, wherein the first and second actuation actions are independent of each other.

### TECHNICAL FIELD

The invention relates to an apparatus for dispensing frozen confectionery, particularly a single serving thereof, comprising particulate material, particularly mixed-in particulate material.

### BACKGROUND AND PRIOR ART

There is a significant consumer demand for frozen confectionery, particularly ice cream, which contains particulate material. When such particulate material is not merely added as a topping but is mixed into the frozen confectionery then they are also referred to as mix-ins.

Apparatus and machines exist which are capable of dispensing a frozen confectionery with a selection of mix-ins that have been selected by an end user. However, almost all of these are for out-of-home use only and are too bulky to be used in an in-home environment.

WO 2011/162796 discloses an apparatus which delivers ice cream and particulate material simultaneously as a single-serve. It also discloses the use of a handle to actuate both the delivery of the ice cream and particulate material simultaneously when the particulate material dispenser is powered. When the particulate material dispenser is not powered it teaches two separate manual actuators for independent control over the delivery of the frozen confection and particulate material respectively.

The machine therefore does not allow the independent control of the delivery of frozen confection and particulate material in a convenient manner.

U.S. Pat. No. 7,621,669 and US 2003/0183090 also disclose devices with a handle that actuates both the ice cream and the particulate material in a non-independent manner.

Improvements in this area would therefore be highly desirable.

### SUMMARY OF INVENTION

The invention relates to an apparatus for dispensing frozen confectionery comprising particulate material, the apparatus comprising:
a frozen confectionery dispenser,
a particulate material dispenser, and
a handle means;
   wherein the handle means is adapted to provide a first actuation action for activation of the frozen confectionery dispenser and a second actuation action for activation of the particulate material dispenser, wherein the first and second actuation actions are independent of each other.

Thus the handle means can actuate both the frozen confectionery dispenser and the particulate material dispenser independently of each other. This allows an end user to carry out the first actuation action to dispense the frozen confection and choose to what extent the second activation action is carried out, to provide control over the degree of activation of the particulate material dispenser. For example, a user could dispense, in one extreme, frozen confectionery with no particulate material at all, and in another extreme, frozen confectionery with a large quantity of particulate material. In addition this flexibility of delivery is provided by a single handle means, which is a particularly convenient method of delivery.

Thus, as the actuation of the particulate material is independently actuated to the actuation of the frozen confection, the first actuation action does not actuate the particulate material dispenser and the second actuation action does not actuate the frozen confectionery dispenser.

In a preferred embodiment the first actuation action comprises translation of the handle means, e.g. moving the handle means from an upper to a lower position. In a preferred embodiment this can actuate a valve which allows the frozen confectionery to be dispensed. In this embodiment it is preferred that the frozen confectionery will be held under pressure so that as soon as the valve is opened, frozen confectionery begins to be dispensed.

Thus, in a particularly convenient embodiment the first actuation action comprises movement of the handle means from an upper position, e.g. wherein a valve is closed, to a lower position, e.g. wherein a valve is open, the valve gradually opening as the handle moves from the upper to the lower position.

In a preferred embodiment, the second actuation action comprises pressing a switch or button. For example, in a preferred embodiment, the second actuation action comprises a button located on the handle means. In this way the button provides independent control of the particulate material dispenser, if for example the first actuation action involves translation of the handle means, as discussed above.

In a preferred embodiment the handle means comprises a region which is grippable by a single human hand so that the single human hand is capable of carrying out both the first and second actuations actions independently of each other.

In a preferred embodiment, a button is located at the end of an elongate portion of the handle means so that the elongate portion can be gripped by a user's hand and the button pressed by a user's thumb. The button may constitute the first or the second actuation action, however preferably it constitutes the second actuation action.

Although the particulate material dispenser can take a variety of forms, it has been found that a particular arrangement allows further levels of independent control of the particulate material dispenser. As such it is preferred that the particulate material dispenser comprises a chamber having an open exit, wherein the chamber is adapted to be rotatable in use such that the open exit follows a pathway having both an upper region and a lower region, and arranged to pass through the lower region at a non-zero speed a plurality of times during a single serving; the open exit being sized to allow a portion of stored particulate material to fall out of the chamber via the open exit under gravity each time the open exit passes through the lower region of the pathway.

In such an arrangement, the container passes through the lower region at a positive speed and therefore for a specific amount of time, so that a controlled quantity of particulate material can leave the container via the open exit. However, as the chamber is rotatable to bring the open exit to the lower region a plurality of times, the amount dispensed each time the open exit passes through the lower region can be a relatively low quantity of particulate material, in particular a quantity that is lower than would eventually be dispensed in the single serving.

Thus, it is highly preferred that the rotation of the chamber is provided by a motor. Furthermore, it is preferred that the second actuation action actuates the motor.

To allow for even further levels of control it is preferred that the second actuation action allows variation in the speed of rotation of the chamber in use. For example, this could be achieved by the button comprising a gradual sensor, which detects the amount by which the button has been pressed. The more the button is pressed the faster the container rotates.

In one particularly preferred embodiment, the user selectable input allows variation in the speed of rotation of the chamber in use. In a further refinement of this embodiment however, it is preferred that the speed of rotation is fixed by the apparatus at a substantially constant value whilst the open exit overlaps with the opening in the housing, i.e. when the open exit is in its lower region. In this way, the amount of particulate material that leaves the open exit in each pass through the lower region is unaffected by the speed of rotation of the chamber. This allows the end user to increase or decrease the speed of rotation, as desired, according to whether more or less particulate material is desired for a single serving.

The apparatus as described and defined herein is primarily intended for use in the home. As such it is highly beneficial if the machine is not so sizeable that it cannot readily be positioned in a user's kitchen for example. As such, it is preferred that the apparatus can fit inside a cuboid container having a volume of no greater than 0.2 m³, preferably no greater than 0.1 m³.

The frozen confectionery material of the present invention may be aerated. The term “aerated” means that gas has been intentionally incorporated into the product, such as by mechanical means. The gas can be any food-grade gas such as air, nitrogen or carbon dioxide. The extent of aeration is typically defined in terms of “overrun” (OR). In the context of the present invention, % overrun is defined in volume terms (measured at atmospheric pressure) as:

$$OR = \frac{\begin{matrix}volume of frozen product - \\ volume of premix at ambient temp\end{matrix}}{volume of premix at ambient temp} \times 100$$

The amount of overrun present in the product will vary depending on the desired product characteristics. In the context of the present invention the level of overrun is typically from 0 to 150%, preferably from 60 to 150%, more preferably from 60 to 100%.

Frozen confection material means a confection made by freezing a pasteurised mix of ingredients such as water, fat, sweetener, protein (normally milk proteins), and optionally other ingredients such as emulsifiers, stabilisers, colours and flavours. Frozen confection materials may be aerated. Frozen confection materials include ice cream, gelato, frozen yoghurt, sorbets, granitas, shaved ices and the like. Preferably the frozen confectionery material is an ice cream.

The particulate material can include discrete pieces of an edible material, such as commercially available confectionery pieces, candy, carbonated candy, chocolate, fruit (which may be e.g. fresh, dried, frozen or sugar-infused), frozen liquids, nut, seed, biscuit, cake, cookie, toffee, cereal, fudge, nougat, jelly, marshmallow and the like. Preferably the particulate material is from 1 mm to 10 mm in size, more preferably from 2 to 9 mm, most preferably from 5 to 8 mm.

The invention will now be illustrated, by way of example only, and with reference to the following figures, in which:

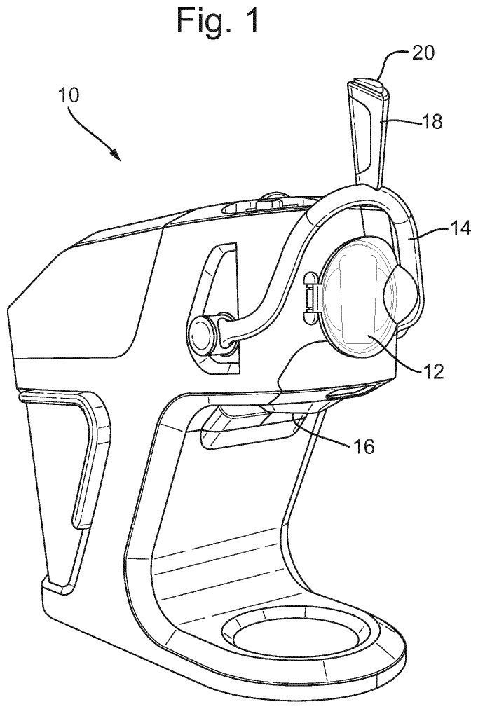

FIG. 1 is a perspective view of an apparatus according to the present invention.

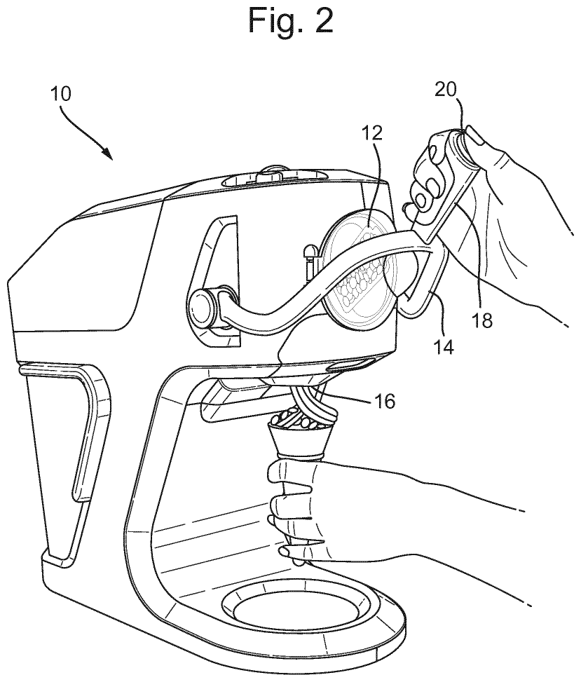

FIG. 2 is a perspective view of the apparatus shown in FIG. 1 in use.

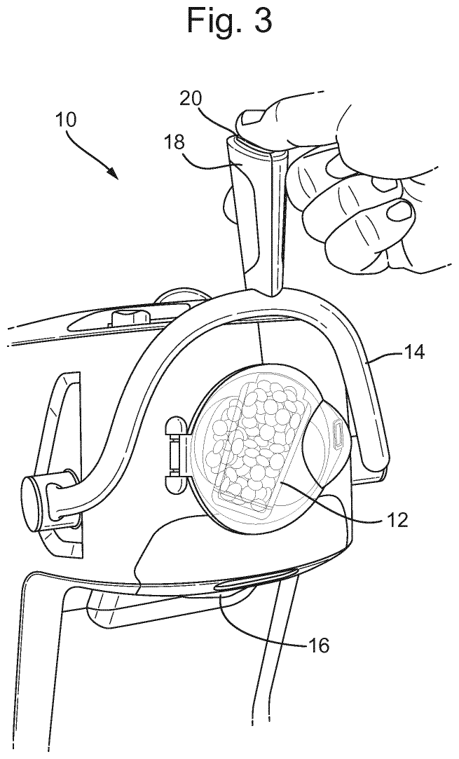

FIG. 3 is a close-up perspective view of the handle means of the apparatus shown in FIG. 1.

Turning to the figures, FIG. 1 shows an apparatus 10 according to the invention which is adapted to deliver a frozen confection, e.g. ice cream, and associated particulate material added at the moment of delivery of the frozen confection. The apparatus is sized to be suitable for use in the home of a user.

The apparatus comprises a source of frozen confection (not shown) and a source of particulate material 12.

The apparatus has a handle 14, the downwards movement of which actuates the delivery of the frozen confectionery out of the outlet 16. The handle also comprises a grippable portion 18 which comprises a button 20 on the end thereof. Pressing button 20 actuates the delivery of the particulate material to be delivered onto the flowing surface of the frozen confection material, as it is being dispensed.

The use of the handle means 14 to independently actuate both the frozen confectionery material and the particulate material is shown in FIG. 2. As can be seen, container 12 can rotate within a stationary housing. The rotation of the rotatable housing is controlled by a motor (not shown) contained within the apparatus body.

Thus, a user can grip the grippable portion 20 and actuate the handle 14 to deliver the frozen confection by pulling downwards to move the handle 14 downwards. Independently of any downwards motion, a user can also press button 20 as desired to add as much or as little particulate material as is desired to the flowing frozen confection. Thus, in use the container 12 rotates and thus an open exit at one end of the container 12 follows a pathway which is a vertical circle. As the container rotates so that the open exit passes through the lower region of the pathway, a portion of particulate material is dispensed to be brought into contact with the flowing surface of the frozen confectionery.

Additionally, as the actuation of the frozen confection and the particulate material is independent, a user could, for example continue to dispense particulate material after a single serving of frozen confection has been dispensed, e.g. in order to generate a topping of particulate material. Alternatively a user can simply not press button 20 at all if no particulate material is desired for that serving.

FIG. 3 shows the handle means in the uppermost position and therefore in a position where no frozen confection is being delivered. However pressing the button 20 can still actuate the particulate material dispenser, as described above.

1. An apparatus for dispensing frozen confectionery comprising particulate material, the apparatus comprising:
a frozen confectionery dispenser,
a particulate material dispenser, and
a handle means;
wherein the handle means is adapted to provide a first actuation action for activation of the frozen confectionery dispenser and a second actuation action for activation of the particulate material dispenser, wherein the first and second actuation actions are independent of each other.

2. An apparatus according to claim 1, wherein the first actuation action comprises translation of the handle means.

3. An apparatus according to claim 2, wherein the translation of the handle means is from an upper to a lower position.

4. An apparatus according to claim 1 wherein the second actuation action comprises pressing a switch or button.

5. An apparatus according to claim 1 wherein the handle means comprises a region which is grippable by a single human hand so that the single human hand is capable of carrying out both the first and second actuations actions independently of each other.

6. An apparatus according to claim 1, wherein the first and or the second actuation action is gradual, wherein the greater the extent of the action is carried out the greater the rate of dispensing of frozen confectionery material and/or particulate material.

7. An apparatus according to claim 1, wherein the particulate material dispenser comprises a chamber having an open exit, wherein the chamber is adapted to be rotatable in use such that the open exit follows a pathway having both an upper region and a lower region, and arranged to pass through the lower region at a non-zero speed a plurality of times during a single serving;
the open exit being sized to allow a portion of stored particulate material to fall out of the chamber via the open exit under gravity each time the open exit passes through the lower region of the pathway.

8. An apparatus according to claim 7, wherein the rotation of the chamber is provided by a motor.

9. An apparatus according to claim 4, wherein the switch or button actuates the motor.

10. An apparatus according to claim 9 wherein the switch or button allows variation in the speed of rotation of the chamber in use.

11. An apparatus according to claim 10, which is adapted to fix the speed of rotation at a substantially constant value whilst the open exit passes through its lower region.

12. An apparatus according to claim 1, which can fit inside a cuboid container having a volume of no greater than 0.2 m³, preferably no greater than 0.1 m³.
